(19) United States
(12) Patent Application Publication
(10) Pub. No.: US 2018/0313208 A1
(43) Pub. Date: Nov. 1, 2018

(54) SYSTEMS AND METHODS OF BI-DIRECTIONAL COMMUNICATION SIGNAL PROCESSING FOR DOWNHOLE APPLICATIONS

(71) Applicant: Alkhorayef Petroleum Company Limited, Al-Khobar (SA)

(72) Inventors: Jedrzej Pietryka, Gdansk (PL); Janusz Szewczyk, Gdansk (PL); Zbigniew Krzeminski, Gdansk (PL); Roman Jurysta, Gdansk (PL); Tomasz Orlowski, Somerville, NJ (US)

(21) Appl. No.: 16/029,150

(22) Filed: Jul. 6, 2018

Related U.S. Application Data
(63) Continuation-in-part of application No. 14/887,779, filed on Oct. 20, 2015, now abandoned.
(60) Provisional application No. 62/066,588, filed on Oct. 21, 2014.

(51) Int. Cl. E21B 47/12; H04B 3/54; E21B 47/00; E21B 43/12

(52) U.S. Cl. CPC E21B 47/12; H04B 3/54; E21B 47/06; E21B 43/128; E21B 47/0007

(57) ABSTRACT

A bi-directional data communications system and associated methods of high speed data communication for transferring data over a three phase power system are provided. Transmission of information uphole is performed using either sequential or simultaneous multiple frequency transmissions, selected to avoid known sources of electric noise. The frequencies are transmitted such that a combination of multiple frequencies or a pattern of frequency transmissions represents the transmitted data. Frequencies used for uphole transmission can be adaptively adjusted by downhole communication of data interpreted by the downhole unit. Digital signal processing including time and frequency domain techniques are used to decode the transmitted data.

### CROSS-REFERENCE TO RELATED APPLICATIONS

This application claims priority to U.S. Provisional Patent Application No. 62/066,588, filed on Oct. 21, 2014, and is a continuation-in-part of U.S. patent application Ser. No. 14/887,779 filed on Oct. 20, 2015, each of which is incorporated herein by reference in its entirety for all purposes.

### TECHNICAL FIELD

The technology described in this document relates generally to data communication systems for downhole equipment. More particularly, it relates to two-way data communications systems and associated methods of high speed data transmission for transferring data over a three-phase power system between a surface and downhole equipment, such as a Down Hole Sensor (DHS), and from the DHS to the surface for an arrangement such as an oil field Electrical Submersible Pump (ESP).

### BACKGROUND

There has been a long history of instrument devices in the oil industry monitoring submersible pumps, and in particular, devices which superimpose data on the 3-phase power cable of such pumps. These devices generally use the ground isolation of the 3-phase system to allow power to be delivered to the downhole instrument and data to be recovered from the device at the surface. These systems remove the need for a separate cable to be installed between the gauge and the surface. The electric submersible pump assembly may also include a data measurement system that measures various parameters. The data measurement system typically receives power from the pump power cable and transmits data though the motor windings and to the surface via the power cable. However, the data transfer rate of such systems is limited by the electrical impedance of the motor windings and the power cable. Additionally, such systems are unable to transmit data in the event of either a partial or complete ground fault.

Most of these conventional instrument systems utilize a direct current (DC) power source at the surface, injected using a high inductance, and a downhole device which, also connected through a high inductance, modulates this DC current supply in a manner that transmits information either as digital bit streams or analog variations like pulse width or height modulation. These conventional systems are negatively affected by insulation faults in the 3-phase power system, and frequently fail as a result of this. Further, such systems are slow in data transmission, having data rates typically less than 1 bit per second.

Other conventional systems have faster data transmission rates and are more tolerant to insulation faults in the 3-phase power system. However, such systems still suffer from problems. For example, these systems do not provide a robust solution for dealing with harmonic noise from variable speed drives, which are frequently used to power submersible pumps. Thus, such a system may fail if harmonics are at the same frequency as a carrier frequency used in the system.

Most of these instrument systems have utilized communication systems in a manner that transmits information either as digital bit streams or analog variations like pulse width or height modulation, but always goes from the DHS—Down Hole Sensor up to the surface Receiver. There is now system which would allow to write back to the DSH and set or change its values/parameters.

Further these existing technologies do not provide any techniques or solutions to write back to the sensor to make corrections from the surface.

The object of this invention is to provide a unique solution for transmission of data from a downhole device over a 3-phase power cable with capability to talk back to DHS, to adjust frequency and other parameters, at substantially higher data rates.

The frequencies transmitted are sent so that a combination of either simultaneous multiple frequencies and/or a pattern of frequency transmissions represents the data transmitted, in a way that it can be adjusted to avoid band of frequency which is noisy and can be re-tuned to avoid it, and to make it highly noise immune.

In this way, the unique problems of transmitting and decoding fast data from a transmitter located downhole on a submersible pump and correcting it on the fly to avoid noise and harmonics are solved.

### SUMMARY

The present disclosure is directed to systems and methods of communicating data over a three phase power system between downhole equipment and a surface. In an example method of communicating data over a three phase power system between downhole equipment and a surface, data words are transmitted between the downhole equipment and the surface using n distinct frequencies, with n being greater than 1. The transmission of a data word includes transmitting a signal comprising the n frequencies ordered in a unique sequence in time, where the unique sequence of frequencies is representative of the data word.

In another example method of communicating data over a three phase power system between downhole equipment and a surface, bits of data are transmitted between the downhole equipment and the surface. The transmission of a bit of data includes transmitting multiple frequencies simultaneously on a transmission line, where a unique combination of frequencies transmitted simultaneously is representative of the bit's value.

In another example method of communicating data over a three phase power system between downhole equipment and a surface, data words are transmitted between the downhole equipment and the surface. The transmission of a data word includes transmitting a unique sequence of frequency combinations, where each frequency combination comprises multiple frequencies transmitted simultaneously on a transmission line. The unique sequence of frequency combinations is representative of the data word.

In another example, a data system is disclosed coupled to an electric submersible pump (ESP), the system comprising: an uphole unit (UHU); a 3-phase power cable coupled to the UHU at one end and a 3-phase motor of an electrical submersible pump (ESP) at another end; a downhole unit (DHU) coupled to the 3-phase motor of the ESP and located downhole in a well, the DHU comprising: one or more sensors; a transmitter sending data from the sensors via the 3-phase power cable uphole to the UHU using two or more frequencies; wherein the UHU comprises a processor configured to provide to the DHU information about the two or more frequencies for sending data uphole, and the DHU further comprises a processor receiving the UHU-provided information and determining the two or more frequencies for sending uphole data.

In different examples, the above uses two or more frequencies selected to avoid sources of electrical noise.

In another example, in the system the UHU provided information is encoded using voltage supply data. Other examples include the data from the sensors sent uphole being formatted by a DHU processor as a data frame comprising a plurality of bits corresponding to sensor data. The data frame may further comprise CRC for ensuring the integrity of the data sent uphole.

In yet another example, the UHU comprises a power supply controller providing predetermined voltage supply values. The DHU may further comprise a comparator for determining, based on the received voltage supply values, of a sequence of binary values, corresponding to select frequency pairs for use in uphole data transmission. The DHU may further comprise at least one each of: a temperature sensor, a pressure sensor, a voltage sensor.

In another example, disclosed is a method of bi-directional communication of data over a three phase power system between downhole equipment and a surface, the method comprising the steps of: transmitting downhole data from the surface to the downhole equipment, wherein the downhole transmission of data includes transmitting voltage levels corresponding to two or more frequencies to be used for subsequent uphole data transmission; transmitting uphole data from the downhole equipment to the surface, wherein the uphole transmission includes transmitting sensor data using the two or more frequencies from the step of downhole transmission.

The example method may include a first combination of frequencies transmitted on the transmission line being representative of a bit having a value of 0, and wherein a second combination of frequencies transmitted on the transmission line is representative of a bit having a value of 1. The method may include a third combination of frequencies transmitted on the transmission line is representative of a control symbol having a value of neither 0 nor 1. The example method disclosed may include a combination of frequencies for uphole data transmission being selected to avoid the frequencies of known sources of electrical noise. The method may further comprise the steps of receiving the transmitted signal and sampling the received signal repeatedly in a time window; and processing the data in the sampled window by applying correlation between an expected signal and the data recovered, wherein said sampling and processing are performed to decode the data. In another example, the step of transmitting bits of data from the surface to the downhole equipment is performed during a predetermined time window. In yet another example, following the step of transmitting bits of data from the surface to the downhole equipment, the method further comprises the step of changing the frequency of at least one of the at least two pairs of phase shifted frequencies for uphole data transmission. In another example, the method further comprises, (a) prior to the step of downhole transmission, the step of transmitting uphole data from the downhole equipment to the surface using two or more frequencies; and (b) following the step of downhole transmission, the step of changing the frequency of at least one of the frequencies used for subsequent uphole data transmission

In yet another example the disclosure provides a method of bi-directional data communication over a three phase power system between downhole equipment and a surface, the method comprising: transmitting a data frame from the downhole equipment to the surface, wherein transmission of the data frame includes transmitting a combination of signals using two or more frequencies over a 3-phase power cable connecting the downhole equipment and the surface, and wherein the data frame transmitted uphole includes at least one of: a pressure data point, a temperature data point, a voltage data point and a CRC value; and transmitting a data frame from the surface to the downhole equipment, wherein the downhole data frame comprises information about at least two frequencies for use in subsequent uphole transmissions.

Downhole data transmission may occur at initialization, or as requested from the surface. Downhole data transmission occurs during pre-determined time window. Downhole data transmission may be encoded using power supply voltage values. The method may further comprise the step of receiving the transmitted downhole signal and sampling the received signal repeatedly in a time window; and processing the data in the sampled window.

### BRIEF DESCRIPTION OF THE FIGURES

FIGS. 1A and 1B depict signals comprising multiple frequencies ordered in unique sequences.

FIG. 1C depicts a transmission of bits of data, where each bit of data is represented by multiple frequencies transmitted simultaneously on a transmission line.

FIG. 1D depicts a transmission of a unique sequence of frequency combinations, each frequency combination including multiple frequencies transmitted simultaneously on a transmission line.

FIG. 2 depicts a block diagram of a multi-frequency coding system.

FIG. 3 depicts a block diagram of a data transmission system utilizing two frequencies.

FIGS. 4 and 5 depict block diagrams of data transmission systems utilizing three frequencies.

FIG. 6 depicts a block diagram of a data transmission system utilizing four frequencies.

FIGS. 7 and 8 depict example signals used in the systems and methods described herein.

FIG. 9 is a block diagram illustrating an example of a bi-directional communications data work flow.

FIG. 10 is a block diagram illustrating an example of a DHU frequency change procedure in a bi-directional system.

FIG. 11 is a block diagram illustrating an example operation transmission from the UHU to the DHU in a bi-directional system.

FIG. 12 is a block diagram illustrating an example of an algorithm for sending frequencies to the DHU with autoscale levels.

FIG. 13 is a block diagram illustrating an example of an algorithm for finding voltage threshold for downhole transmission using autoscale levels procedure.

FIG. 14 is a block diagram illustrating an example of an algorithm for finding a voltage pair for transmission from the UHU to the DHU.

FIG. 15 is a schematic diagram of a system for communication between a surface located uphole unit (UHU) and a downhole unit (DHU).

FIGS. 16A-16D further illustrate the process of finding a voltage pair shown in FIG. 14.

FIG. 17 is a block diagram illustrating an example UHU procedure to send data to DHU.

### DETAILED DESCRIPTION

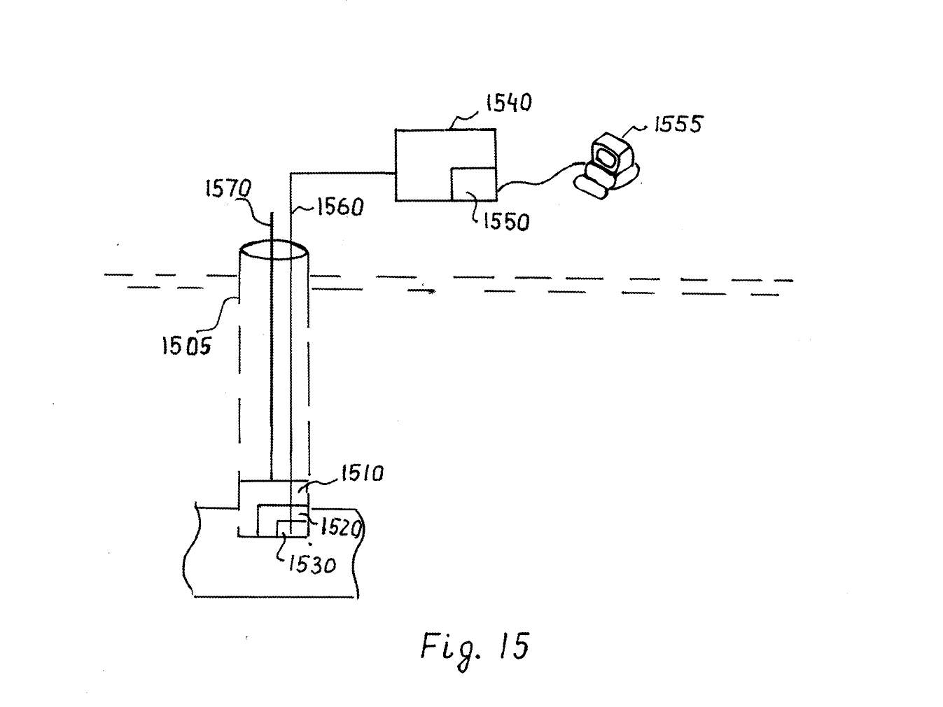

The approaches described herein implement data communications systems and associated methods of high speed data transmission for transferring data over a three phase power system. Such systems and methods may be used for data communication between a surface and downhole equipment, among other uses. Example downhole equipment includes a downhole sensor (DHS) for an arrangement such as an oil field electrical submersible pump (ESP). FIG. 15 is a schematic diagram of such a system for communication between an uphole unit (UHU) 1540 (also referred to as a surface unit (SU)), and a downhole unit (DHU) 1520. An electric submersible pump (ESP) 1510 may be coupled to the downhole end of the production tubing 1570. The ESP may pump the oil or other resource of the subterranean resource through the production tubing 1570 to the production equipment at the surface. The ESP 1510 is connected to and receives power from a 3-phase power cable 1560 that provides power to the ESP 1510 for operation. The 3-phase power cable 1560, which in practice can be very long (kilometers), is coupled to an ESP controller 1550 at the surface. The ESP controller 1550 may provide control and power to ESP 1510 via the 3-phase power cable 1560. The operation of the system may be controlled by an operator at a computer console 1555.

As discussed above, conventional systems for data communication between a surface and downhole equipment suffer from a number of problems. It is noted, however, that the systems and methods described herein are not limited to data communication between a surface and downhole equipment, and that the approaches described herein can be used in a wide variety of data communications systems where one system component provides information by means of a very weak signal that can be lost in background noise.

For example, conventional systems do not provide a robust solution for dealing with harmonic noise from variable speed drives, which are frequently used to power electrical submersible pumps. Thus, these systems may fail, i.e., for example be unable to communicate information to the surface unit, if such harmonics are at the same frequency as a carrier frequency used in the system. In this regard, it is notable that once a DHU is lowered into the ground, if the unit cannot effectively communicate information to the surface it may become economically unfeasible to operate it or lift it up to the surface for repairs and adjustment, potentially resulting in huge economic losses.

The systems and methods described herein may be used to remedy this problem, as described below, by enabling reliable transmission and decoding of signals even in the presence of harmonic noise. Notably, this is true even in the case when the frequency or frequencies of the harmonic noise are different because of the different drives being used. Additionally, a fundamental problem of information transmission systems using frequency transmitted signals to pass information is the degree of attenuation of the signal between the transmitter and the receiver. This problem is particularly severe in oil field pump monitoring because of the long cable lengths, which can be as high as 10 Km. The systems and methods described herein may be used to address this problem by providing data transmission and detection systems and methods suitable for robust decoding of signals which suffer from such attenuation.

Further, conventional systems do not provide robust or unique methods of decoding data and rely heavily on traditional frequency modulation (FM) decoding techniques. The problems of using such traditional FM decoding is that the information may contain time segments where the recovered signal is mostly noise and does not contain the transmitted carrier frequencies and also time segments where severe attenuation has made the signal so small that effective FM decoding is not feasible. The systems and methods described herein do not rely on traditional FM decoding and instead provide unique solutions to decoding data. Substantially higher data rates may be achieved using the transmission and decoding methods described herein.

As described in detail below, the approaches of the instant disclosure include the transmission of information from downhole equipment to surface using either sequential frequency transmissions (e.g., transmitting a signal including n frequencies ordered in a unique sequence) and/or transmissions of multiple frequencies simultaneously. The transmitted multiple frequencies can be of regular or irregular patterns and transmitted in a way that differentiates the transmitted data from coherent motor supply (VSD) noise and/or background noise. The multiple frequencies transmitted are used to represent the data that is being transmitted in a way that is both unique to decode and able to be decoded in several ways to provide redundancy and noise immunity.

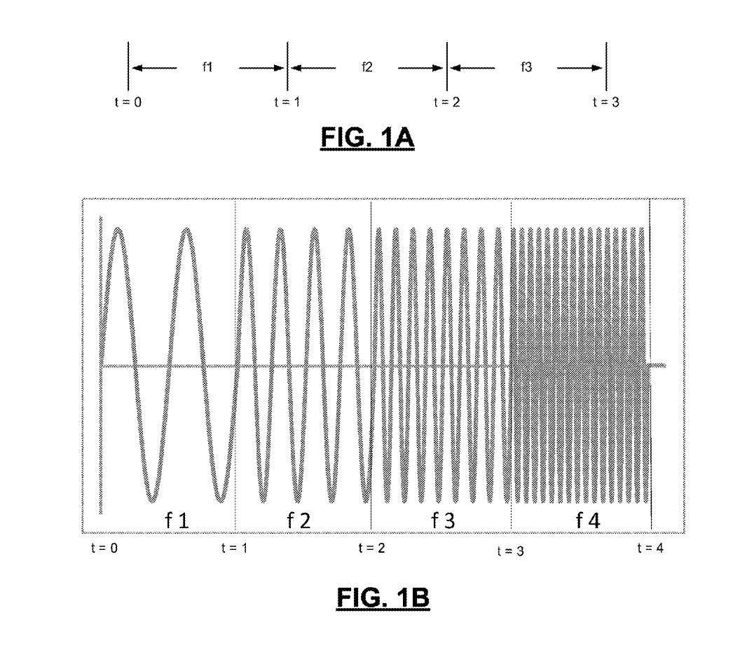

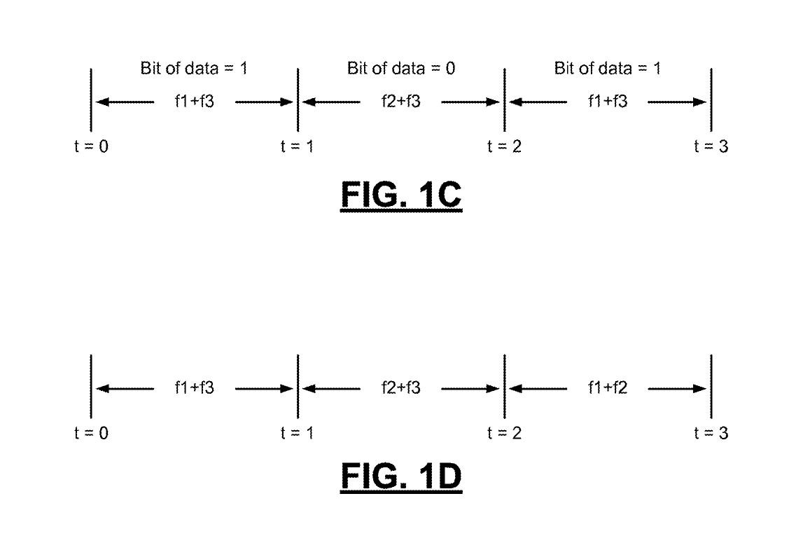

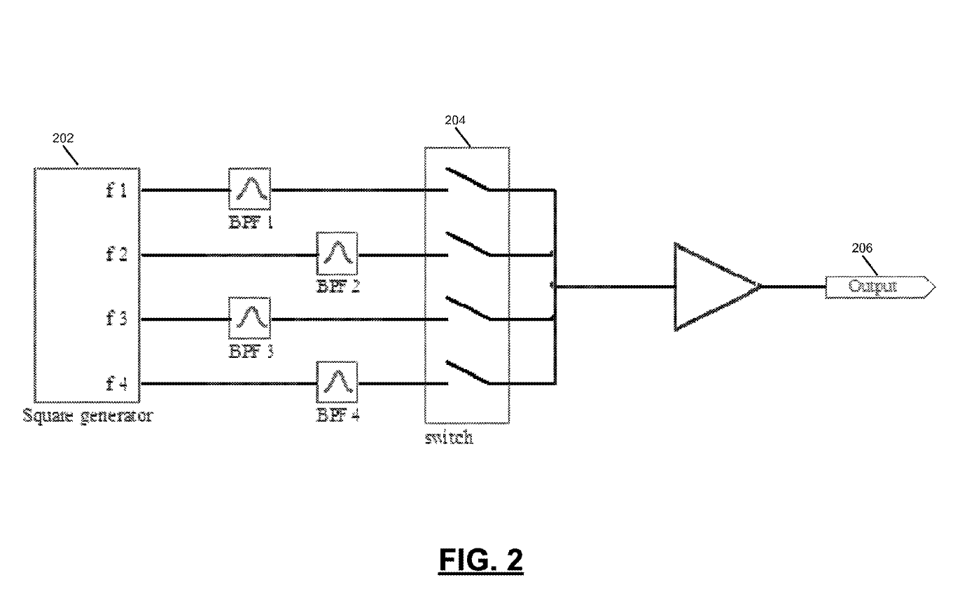

Time and frequency domain analysis techniques are used to provide a powerful and specific method of recovering specially encoded data that solves data decoding problems present in conventional systems. In this manner, the unique problems of transmitting and decoding data from a transmitter located downhole on a submersible pump are addressed. FIGS. 1A-1D provide an overview of example techniques used in the systems and methods of the present disclosure. Additional details on such techniques are provided below with reference to FIGS. 2-8.

### Multi Frequency Encoding Example

In an example method of communicating data over a three phase power system between downhole equipment and a surface, data words are transmitted between the downhole equipment and the surface using n distinct frequencies, with n being greater than 1. The transmission of a data word includes transmitting a signal comprising the n frequencies ordered in a unique sequence in time, where the unique sequence of frequencies is representative of the data word. To illustrate this, reference is made to FIG. 1A. As shown in this figure, a data word may be transmitted using n=3 distinct frequencies (i.e., noted as being f1, f2, and f3 in the figure). The transmission of the data word includes transmitting a signal including the three frequencies f1, f2, and f3 ordered in a unique sequence in time.

In the example of FIG. 1A, the unique sequence of “f1|f2|f3” represents a particular data word. By changing the sequence of the frequencies transmitted in the signal, other data words are transmitted (e.g., by changing the sequence to “f2|f3|f1,” a second data word may be transmitted). In an example, the n distinct frequencies enable n! (i.e., n factorial) unique data words to be transmitted. Thus, in the example of FIG. 1A, the use of n=3 distinct frequencies enables 3! (i.e., 1*2*3) unique data words to be transmitted. The example of FIG. 1A thus utilizes multiple frequencies, where such frequencies are transmitted in unique sequences that represent data words.

In the example of FIG. 1A, n can be any number greater than one. Thus, for example, FIG. 1B illustrates an example in which n=4. In this example, the transmission of a data word includes transmitting a signal including the four frequencies (i.e., f1, f2, f3, and f4, as illustrated in the figure) ordered in a unique sequence in time, where the unique sequence of frequencies represents a particular data word. In FIG. 1B, the sequence of “f1|f2|f3|f4” represents one such data word. As shown in the figure, the transmission of the multiple frequencies may utilize sinusoidal waves, but it is noted that the frequencies may be transmitted utilizing square waves, rectangular waves, or other periodic signals in other examples.

In another example method of communicating data over a three phase power system between downhole equipment and a surface, bits of data are transmitted between the downhole equipment and the surface. The transmission of a bit of data includes transmitting multiple frequencies simultaneously on a transmission line, where a unique combination of frequencies transmitted simultaneously is representative of the bit's value. To illustrate this, reference is made to FIG. 1C. As shown in this figure, the transmission of a bit of data having a value of “1” may be accomplished by transmitting multiple frequencies f1+f3 simultaneously on a transmission line. To transmit a bit of data having a value of “0,” multiple frequencies f2+f3 are transmitted simultaneously on the transmission line. Each unique combination of frequencies transmitted simultaneously is thus representative of a bit's value.

It is noted that the scheme illustrated in FIG. 1C (e.g., where “f1+f3” represents a “0” bit and “f2+f3” represents a “1” bit) is only an example, and other schemes are used in other examples. It is further noted that although the example of FIG. 1C utilizes n=3 frequencies (i.e., f1, f2, and f3, as illustrated in the figure), n can be any number greater than one.

In another example method of communicating data over a three phase power system between downhole equipment and a surface, data words are transmitted between the downhole equipment and the surface. The transmission of a data word includes transmitting a unique sequence of frequency combinations in time, where each frequency combination comprises multiple frequencies transmitted simultaneously on a transmission line. The unique sequence of frequency combinations is representative of the data word. To illustrate this, reference is made to FIG. 1D. As shown in this figure, a data word may be transmitted using a sequence of three frequency combinations. In the figure, a first frequency combination is “f1+f3,” where these frequencies are transmitted simultaneously on a transmission line. A second frequency combination is “f2+f3,” where these frequencies are transmitted simultaneously on the transmission line. A third frequency combination is “f1+f2,” where these frequencies are transmitted simultaneously on the transmission line.

In the example of FIG. 1D, the unique sequence of “f1+f3|f2+f3|f1+f2” represents a particular data word. By changing the sequence of the frequency combinations, other data words are transmitted (e.g., by changing the sequence to “f1+f2|f2+f3|f1+f3” a second data word may be transmitted). The example of FIG. 1D may be seen as a combination of the methods described above with reference to FIGS. 1A and 1C. Specifically, a sequence is used to represent a data word (e.g., as is used in the method of FIG. 1A) and each entry of the sequence includes a transmission of multiple frequencies simultaneously (e.g., as is used in the method of FIG. 1C). It is noted that although the example of FIG. 1D utilizes n=3 frequencies (i.e., f1, f2, and f3, as illustrated in the figure), n can be any number greater than one. As discussed in more detail below, in alternative examples the system of this invention may use pairs of phase shifted frequencies, with the advantage of using shorter time intervals for data transmission.

### Example Multi Frequency Coding System

As described in further detail below, with reference to FIGS. 2-8, the approaches of the instant disclosure implement both a unique method of data transmission and also a unique method of decoding such data. Simultaneous frequency transmission can be used to either increase data compression and data rate, and/or to provide increased redundancy and provide a system which is not sensitive to interference at a single frequency, such as harmonic noise from a large 3-phase variable speed drive. With the system described herein using multi-frequency coding, fast data transmission can be achieved using a variety of signal frequencies (e.g., frequencies lower than 10 kHz).

FIG. 2 is a block diagram of an example multiple frequency coding system that may be used in the approaches described herein. As shown in the figure, a frequency generator 202 (e.g., a square-wave generator, a sinusoidal wave generator, a rectangular wave generator, etc.) is capable of generating multiple frequencies. In the example of FIG. 2, one to four frequencies are used, although this can be extended to any number. The frequency generator 202 is coupled to switches 204. In this example, by closing a particular switch, a signal having one of the four frequencies f1, f2, f3, f4 is coupled to an output 206. By opening and closing the switches in different sequences in time, the different frequency signals appear in different sequences. Each sequence represents one and only one specific data word, and the data word is subsequently received and properly interpreted by a surface unit. Then number of frequencies used gives n! (i.e., 1*2*3* . . . *n) possible sequences. In this manner, the example multiple frequency coding system may be used in implementing the method described above with reference to FIG. 1A.

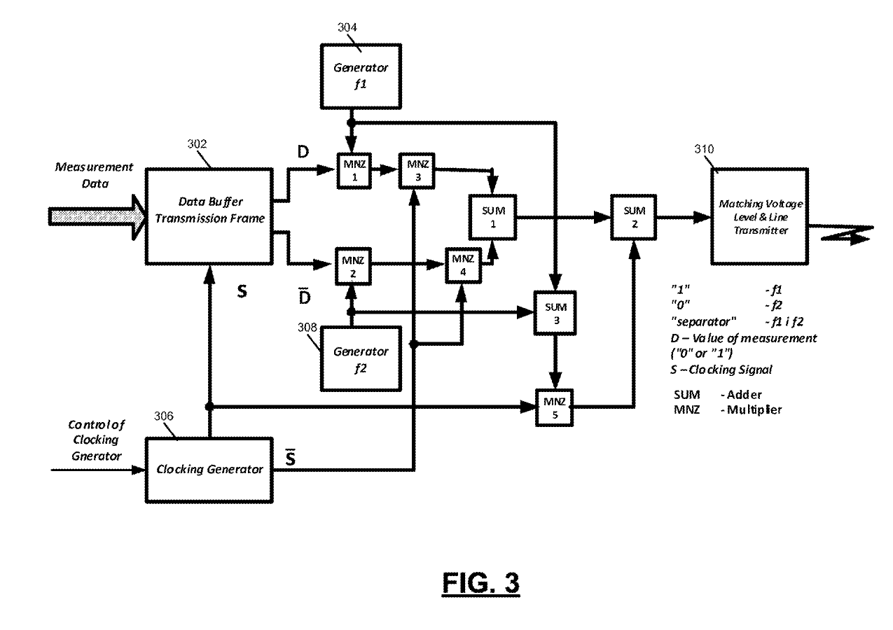

As described above with reference to FIGS. 1C and 1D, methods of communicating data may include transmitting multiple frequencies simultaneously on a transmission line. An example system that may implement such a method is shown in FIG. 3. This figure shows an example of using two frequencies for transmission of a measurement data signal. A first of the two frequencies is used to transmit the logical value “1,” and a second of the two frequencies is used to transmit the logical value “0.” Specifically, an instance in the data transmission line signal with a frequency of f1 indicates a transferring of the value “1,” and an instance in the data transmission line signal with a frequency of f2 indicates a transferring of the value “0,” in the example of FIG. 3. This combination can be completed with a case in which two frequencies are transmitted simultaneously on the transmission line, which can be interpreted as a signal separation (e.g., space).

The signal separation is a data symbol representing neither “0” nor “1.” The signal separation symbol can be used both to pass on information about the beginning/end of the data frame transmission (e.g., synchronization start/stop), as well as to the pass on information about possible separation of “zeros” and “ones” in the course of transmission within the frame. For example, similar to the structure used in Morse telegraphy signals, a long combination of f1 and f2 (“dash”) may indicate a start/stop transmission of data frames, and a short combination (“dot”) may indicate a separator of “zeros” and “ones” inside the same frame. The system of FIG. 3 enables relative simplicity in the underground part of the DHS transmission system, including a simplicity of logic, which allows for the implementation of both the software and hardware. Although the example of FIG. 3 may exhibit some sensitivity to noise at frequencies similar to those used in data transfer (e.g., sub-harmonic of converter drives), this can be counteracted by lengthening the duration of logic “1” and “0” and carefully selecting the carrier frequencies (e.g., so as to form a pair of primes).

In FIG. 3, measurement data and the device address are stored in a data buffer 302 to form a transmission frame. Such a frame, depending on the degree of complexity of the components, can contain one or more measurement data. In the case of cyclic buffer power, measuring device address can be added in the buffer 302, or it can be the default. The data buffer 302 is clocked from clock signal generator 306 whose output signal and the signal negation are used to control the signal transmission to the surface. In the case where the data (D) has a Boolean value “1,” the carrier signal generated by the signal generator f1 304 is released in the block MNZ1 (1×f1=f1) and received at an adder SUM1. At the same time, when the negated output from the buffer is a Boolean value “0,” this blocks the generator 308 output f2 in the block MNZ2.

The MNZ3 block is unlocked when it accepts the negated control signal from the clocking generator having a Boolean value “1,” which means the system has completed the process of determining the value of output from the buffer data. Through block adders SUM1 and SUM2, the f1 signal is transmitted for the duration of a logical “1” to the matching circuit 310 for the voltage level transmission and line transmitter. The system functions in a similar manner when transmitting a logical “0” via the signal frequency f2.

Separation of the individual logical values of measurement data is carried out by generating a signal that is a superposition of signals with frequencies f1 and f2 (e.g., equal to f1+f2, by transmitting these two frequencies simultaneously). This is accomplished in adder block SUM3. The output from the adder block SUM3 is unlocked in block MNZ5 for the duration of the rewriting of the new value of the output data buffer, clocked by the signal from the clocking generator 306 having a logical “1.” Through block SUM2, the separation signal f1+f2 is transmitted to the matching circuit 310 for the voltage level transmission and line transmitter.

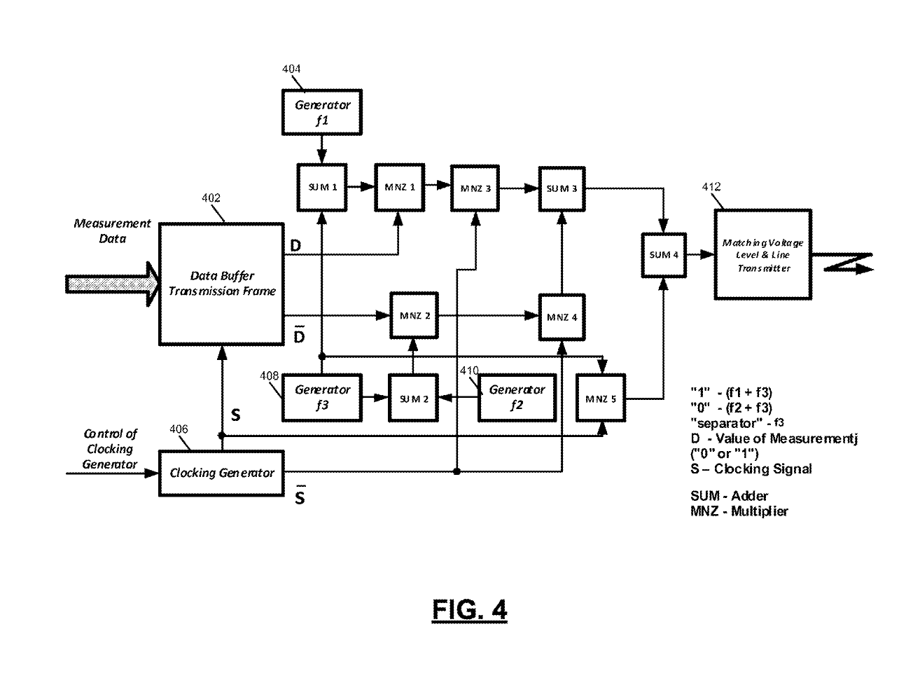

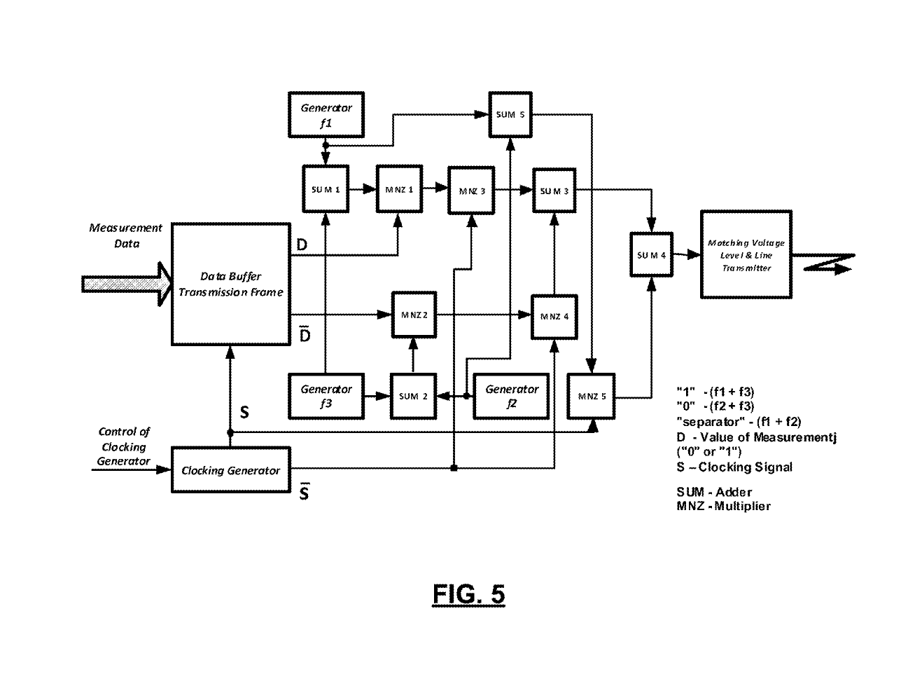

In FIG. 4, a third frequency is introduced, and this is designed to increase transmission immunity to electrical interference occurring in the signal transmission path, which may include the electric power supply to the pump motor. In this example, data signal transmission is a suitable combination of two of the three frequencies. Specifically, an instance of the data transmission signal that is the sum of the frequencies of signals f1 and f3 indicates a transferring of the value “1,” and an instance of the data transmission signal that is the sum of the frequencies of signals f2 and f3 indicates a transferring of the value “0,” in this example. This combination can be supplemented by the case in the transmission line where only the signal with a frequency f3 is transmitted, which can be interpreted as a signal separation (e.g., space). The signal separation symbol can be used to pass on information about the beginning/end of the data frame transmission (e.g., sync start/stop) and to pass on information about the possible separation of “zeros” and “ones” in the course of transmission inside the frame. Thus, it may be assumed that a longer duration signal in f3 (“dash”) means a start/stop transmission of data frames, and a short duration (“dot”) means a separation of “zeros” and “ones” inside the same broadcasting frame.

The system of FIG. 4 has a higher complexity than the system of FIG. 3, but the system of FIG. 4 has greater immunity to interference and sub-harmonics (e.g., coming from the pump motor control). In FIG. 4, measurement data and the device address are stored in the data buffer 402 to form a transmission frame. Such a frame, depending on the degree of complexity of the components, can contain one or more measurement data. In the case of cyclic buffer power, a measuring device address can be added in the buffer 402, or it can be the default. The data buffer 402 is clocked from clock signal generator 406 whose output signal and its signal negation are used to control the signal transmission to the surface. In the case where the data signal (D) has a Boolean value “1,” the block MNZ1 releases the combination of frequencies f1+f3 (i.e., 1×(f1+f3)). The signals f1 and f3 are generated by frequency generators 404 and 408, respectively. At the same time, when the output from the negated buffer is a Boolean value “0,” this blocks the output of the block MNZ2 carrier signal (i.e., 0×(f2+f3)). The signal f2 is generated by block 410.

The MNZ3 block is unlocked when it accepts the negated control signal from the clocking generator 406 having a Boolean value “0,” which means that the system has completed the process of determining the value of output from the buffer data. Through adder blocks SUM3 and SUM4, carrier signal “1” (f1+f3) is transmitted for the duration of a logical “1” to a matching circuit 412 for the voltage level transmission and line transmitter. In a similar manner, a logical “0” is transmitted using a carrier signal that is the sum of the frequencies of signals f2 and f3. Separation of the individual logical values of measurement data is carried out through the use of a signal with a frequency f3 for the duration of the data feed in the data buffer 402. This is accomplished by using block MNZ5, which transmits its output to adder SUM4.

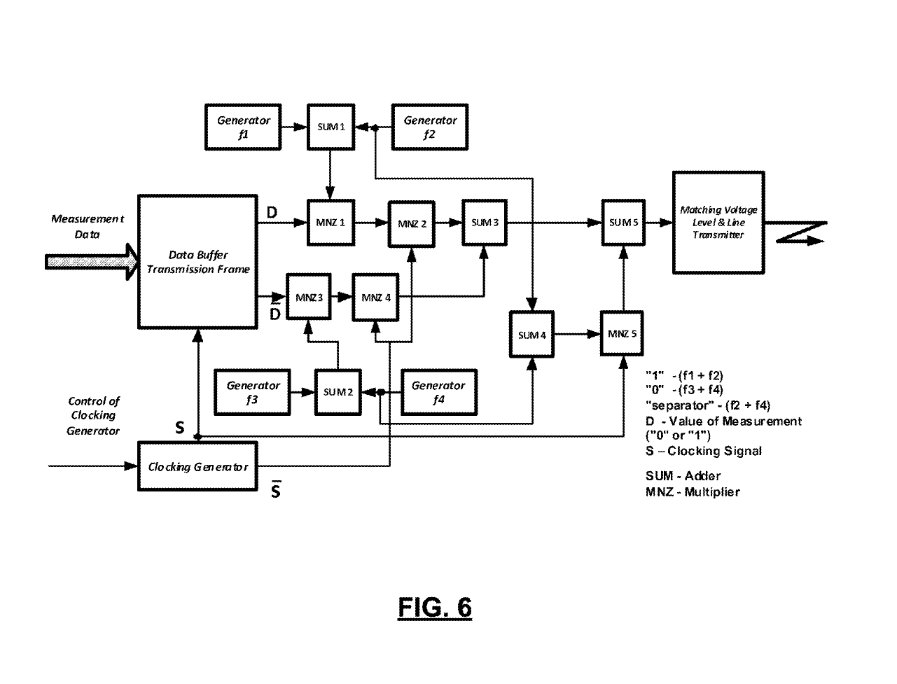

It is noted that in FIG. 4, the single frequency f3 used for the separator data symbol may be sensitive to interference. In an example, this sensitivity is eliminated by using a combination of frequencies for the separator data symbol. Such an example is shown in FIG. 5. The system of FIG. 5 operates in a manner that is similar to that of FIG. 4, except that the control characters' (start/stop and separator) carrier signal uses the sum of two signals in FIG. 5. In this example, the sum can be calculated by summing the signals with frequencies f1 and f2.

In FIG. 6, a fourth carrier frequency is introduced. This provides high immunity to interference for all transmitted components (e.g., logical values “0” and “1,” separation, start and stop). In FIG. 6, an instance of the data transmission signal that is the sum of the signals of frequencies f1 and f2 indicates a transferring of the value “1,” and an instance of the data transmission signal that is the sum of the signals of frequencies f3 and f4 indicates a transferring of the value “0.” This combination can be supplemented by the case where in the transmission line signals, there is a sum of the frequencies of signals: <f1 & f3> or <f1 & f4> or <f2 & f3> or <f2 & f4>. Such pairs can be used to control the transmission, for example, as symbols: (1) the separation of “zeros” and “ones” within the frames of data transmission, (2) the beginning of the data frame transmission, (3) the end of the data frame transmission, and (4) the repetition of data frame transmission.

For each combination of the above-mentioned sum of signals, additional media information can be included using the duration of the signal (e.g., type “dot” and type “dash”) which will increase the number of possible combinations of control symbols up to eight. This enables the system to significantly increase the immunity to potential transmission interference and decrease errors. Further, a different duration of the signals that make up each of the signals noted above may be introduced, in examples. Knowledge of the specific relationship between the duration of signals in the package (or any other combination than simple summation) allows for the expansion of the elements to increase the safety and security of the transmission. FIG. 6 shows an exemplary schematic diagram of a data transmission system based on the use of four carrier frequencies. The operation of the system of FIG. 6 is similar to that of FIGS. 3-5.

It will be appreciated that the entire system can be modified to use pairs of 180° phase shifted frequencies as discussed below. The required circuit modifications are within the scope of one skilled in the art and will not be discussed in further detail herein.

### Example Upstream Signals

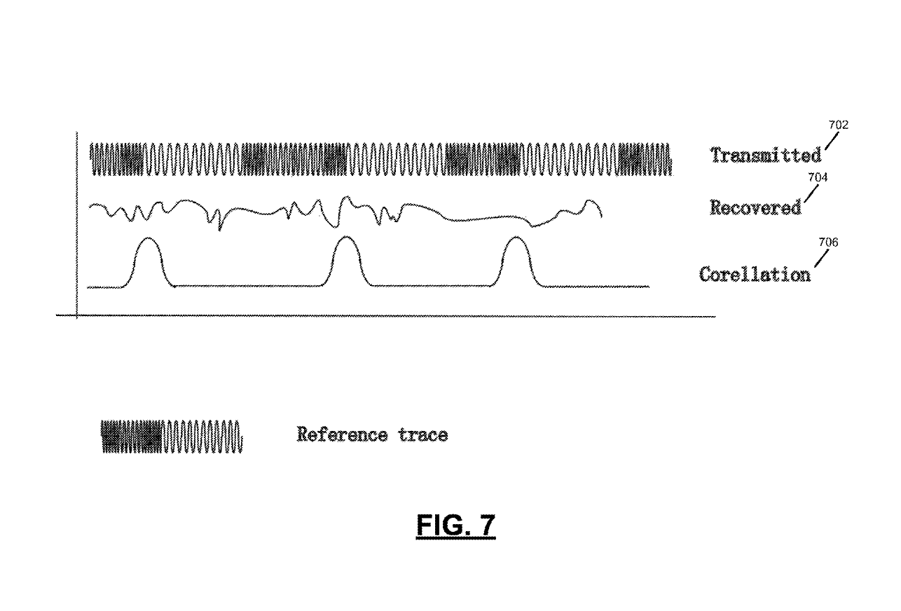

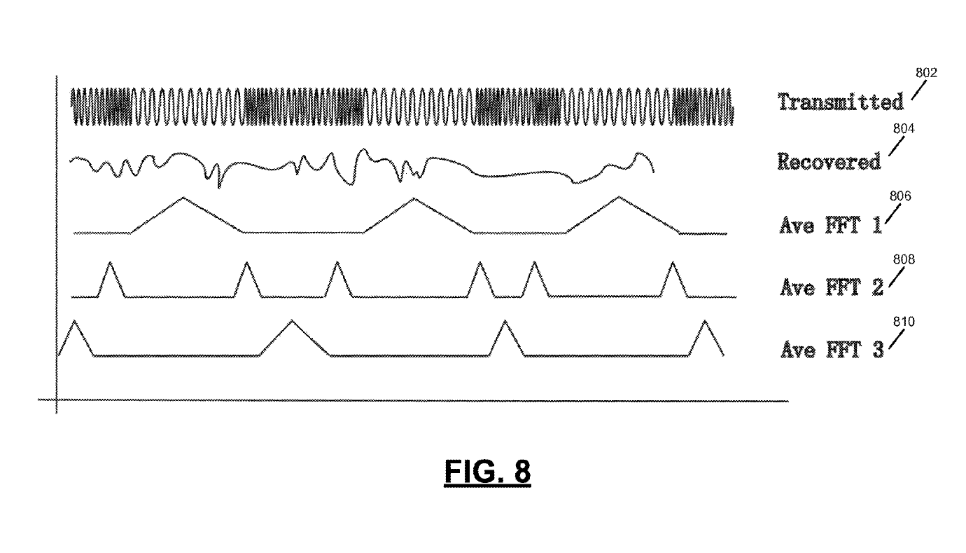

FIGS. 1-6 describe a unique and inherently noise immune uphole data transmission system. To complement this transmission system, systems and methods for decoding and retrieving information in the transmitted data are described below with reference to FIGS. 7 and 8. Thus, as described below, data recovery can be accomplished in a unique way that provides robust data recovery in the presence of high signal attenuation and also significant coherent noise in the same frequency band of the data. The use of digital signal processing, as utilized in the systems and methods described below, can provide the opportunity to perform data processing that in analog systems would be difficult and in some cases not practical to implement. In the digital signal processing system, a processor system is able to capture an analog signal with sufficient speed and resolution such that digital filtering and other numerical processing can be applied to it.

It is noted that the digital processing may apply traditional filtering to acquired signals before any of the following process steps are applied. One benefit of the digital filtering is that it cannot resonate. Very narrow bandwidth and high gain analog filters are prone to free oscillation at the frequency center of the filter, and this is a problem not present with digital filtering. This has relevance in the decoding process because a free oscillating filter will generate a frequency at one of the FM carrier frequencies and can be erroneously decoded in a simple FM system as a “1” or a “0.” By using patterns and sequences for each piece or bit of data (as used in the systems and methods described herein) this cannot happen.

Reference is now made to FIG. 7. In this example, the recovered signal 704 is sampled repeatedly in a time window that is the same length as the transmitted sequence. The transmitted sequence can include (i) single frequencies transmitted in a sequence, and/or (ii) frequency combinations (e.g., each frequency combination comprising multiple frequencies transmitted simultaneously) transmitted in a sequence, as described above. The data in this sampled window can then be processed by applying correlation 706 between the expected signal and the data recovered. In this manner, the transmitted data patterns 702 are recognized even with significant coherent noise, as the noise will not respond to the correlation.

### FFT Processing Methods

Reference is now made to FIG. 8. There may be occasions where the recovered data is not of sufficiently high amplitude or is distorted by noise and other electrical signals. A process using a fast Fourier Transform (FFT) analysis, as illustrated in FIG. 8, can alleviate this issue. The process consists of sampling the recovered data 804 repeatedly in a window that is the same length as the transmitted sequence or combination of frequencies. The transmitted signal is shown at 802 in FIG. 8. An FFT is carried out on the sampled waveform, and this FFT is analyzed in small frequency windows for average amplitude. This is done repeatedly at a sample rate suitable for the pattern transmission rate that is being detected. This is shown at 806, 808, 810 in FIG. 8. Over a period of time, the only variation which will occur and alter in a sequence window to sequence window time frame will be the changing frequency combinations and patterns. The average FFT amplitude therefore will show these amplitude changes at the specific frequencies of interest, with the only limitation being the vertical sample resolution of the captured data. This provides a very powerful method of detecting specific frequency patterns and combinations even when the amplitude is both very low and considerably smaller than the background noise and harmonic interference.

### Bi-Directional Communication Processing

The preceding disclosure focuses on signals from the Down Hole Unit (DHU) to the Up Hole Unit (UHU) and processing techniques for extracting information therefrom. This section focuses on bi-directional communications between the UHU and the DHU, suitable for information gathering based on adjustable signal processing techniques.

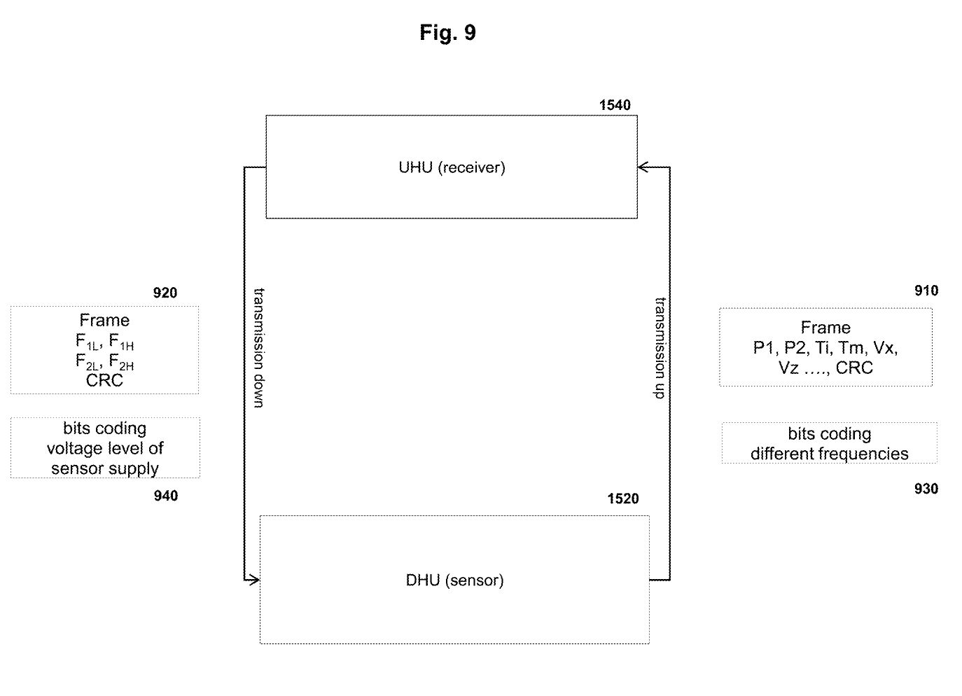

FIG. 9 is a block diagram illustrating an example of a bi-directional data work flow. As shown, there is a bi-directional data work flow between the UHU, also referred to as Surface Unit (SU), 1540, which in general is a receiver of downhole information, and DHU (sensor) 1520. In a preferred embodiment, communication from DHU 1520 to the surface includes parameters such as Pressure values, Temperature values, Voltage values, and other parameters of the DHU and ESP operation, as needed, preferably along with a cyclic redundancy check (CRC), a type of error detecting code to ensure data integrity of the entire transmission. CRC coding is generally known in the art and will not be described herein in further detail. The uphole data is assembled in one example as a Frame 910 including, for example, parameters P₁, P₂, Ti, Tm, Vx, Vz . . . , CRC. In a specific example, the data frame for uphole communication has 16 data bits length. It will be appreciated that additional or different parameter values may be communicated, as necessary in one or more data frames. That is, the communication need not be assembled as a single data frame, but may also be split up into different frames. The content and size of the data frame (including number of bits transmitted, and possibly a frame number) may change, as necessary as well. As further illustrated in the figure, in a specific example, the coding mechanism 930 used for the communication to the UHU 1540 uses different frequencies. Two pairs of frequencies may be used in one embodiment, where, for example, a bit value set at a logical 0 corresponds to frequencies F_{1L} and F_{2L}, and a bit value at a logical 1 corresponds to frequencies F_{1H} and F_{2H}, as further described below. More frequencies can be used, as necessary, to convey additional information.

Downhole communication from UHU 1540 to DHU 1520, in one example illustrated in frame 920 in FIG. 9, may include two pairs of phase-inverted frequencies, generally used to control the frequencies of the uplink module, as described above. For illustration, the first frequency pair is designated as F_{1L} and F_{1H}, and the second frequency pair as F_{2L} and F_{2H}. It will be appreciated that F_{1L} and F_{1H} have the same frequency, but are 180° phase shifted. Likewise, F_{2L} and F_{2H} have the same frequency, but are 180° phase shifted. In this example, the collection carries four different (two-by-two phase shifted) frequencies. It will be appreciated that other combinations of frequencies can be used for the uphole transmission. To protect the integrity of the communication, frame 920 may also include a CRC, to ensure reception in the DHU of accurate information from the surface. In a specific example, the data frame for communication to DHU 1520 may have 9 data bits length.

In one example, the coding mechanism 940 used for the communication from UHU 1540 to DHU 1520 uses different sensor supply voltage levels. For example, a logical 0 bit coding may correspond to supply voltage Ulow, while a logical 1 bit coding may correspond to Uhigh supply voltage. It will be appreciated that downhole transmissions are typically done on setup, or when needed, such as to protect from random frequency changes and harmonic noise.

Accordingly, with reference to the example illustrated in FIG. 9, in the transmission down branch, the UHU 1540 communicates with the DHU 1520 by changing the supply voltage of the sensor that produces the pulsed width modulation (PWM) power supply controlled from the microprocessor in the UHU. The coding 940 of bits in the frame 920 is performed by different levels of the supply voltage, e.g., for a bit with a logic value of 0 the supply voltage is set to 170V, for a bit with a logic value 1 the supply voltage is set to 190V, or other such values as appropriate.

In the transmission up branch, communication of the DHU 1520 with the UHU 1540 is done by transmitting the assigned appropriate frequencies. In the specific example illustrated in FIG. 9, only one of n (n≥2) frequencies can occur at any given time. The frequencies are assigned to values of logic bits. In the example of n=2, the first frequency may correspond to a logic 0, the second to a logic 1. In order to increase transmission reliability, two pairs of such frequencies can be used in 930 for transmission of consecutive frames, i.e. the bits of the first frame are encoded with the first pair of frequencies, bits of the second frame are encoded using the second pair of frequencies. The process may repeat, with the odd frames being encoded with the first frequency pair, and the even frames being encoded with the second pair of frequencies. As discussed, Frame 910 transmits the various sensor data, along with CRC coding for robustness. Various coding modifications as discussed herein may be used in alternative examples.

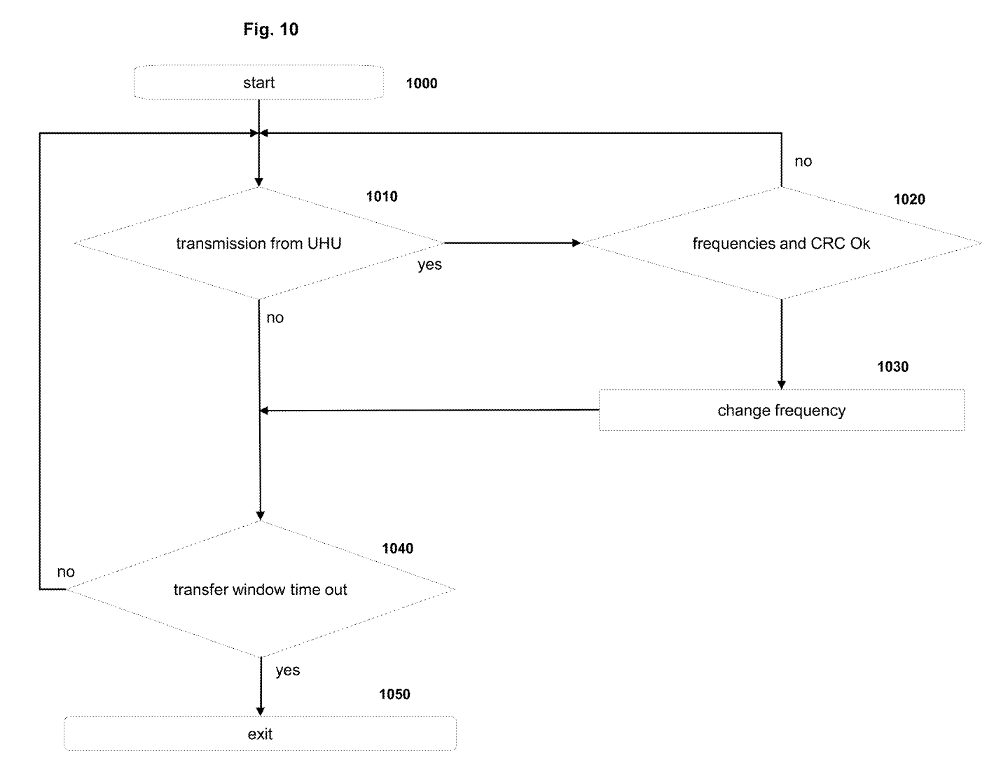

FIG. 10 is a block diagram illustrating an example of a DHU frequency change procedure, initiated as explained below. The example algorithm is particularly suited for optimized communications when harmonic noise and other parameters in the downhole environment deviate from those expected and may cause decrease in the signal quality. With reference to FIG. 10, processing is initiated in step 1000. The following processing block 1010 determines if there has been a communication from the Up Hole Unit (UHU). If there has been no communication, the algorithm proceeds to processing block 1040 which, as described below, determines whether the time allotted for UHU communications has expired. Alternatively, if signal transmission from the UHU is detected in block 1010, the following processing block 1020 determines if the received transmission signals are valid. That is, whether data bits from the comparator corresponding to the received frequencies and CRC code(s) conform to expected values. In an example, block 1020 compares received bit values to those expected in a legitimate transmission. If the received frequencies and CRC are not as expected, processing cycles back to block 1010 to determine if there has been a valid transmission from the UHU. If the received frequencies and CRC are as expected, the following processing block 1030 sets new frequency values for transmission to the UHU receiver in subsequent communications. It will be appreciated that the new frequency values used in uphole transmission (see reference block 930 in FIG. 9) are set in a manner expected to avoid harmonic or other types of noise that may degrade the performance of the communication system.

In sum, during a prescribed period of time, the algorithm shown in FIG. 10 checks for communications from the UHU that serve to determine whether signals received from the DHU have acceptable signal-to-noise ratio to be properly interpreted and processed. The time window 1040 is for potentially setting the frequency of the DHU transmission after turning on its power supply. That is, DHU receives data as a Hi/Lo state given to the microcontroller from an external hardware digital comparator in 1010. After selecting the correct frame in the time setting window of the frequency codes, the next transmission to UHU proceeds on new frequencies.

DHU in the absence of reception of the correct frame from UHU works with the set frequencies in FLASH memory at the stage of actuating the sensor. Once information is received from UHU, the new frequencies are saved in the Flash memory, and will be used for transmission from that point onwards. In case of the sensor restart (DHU), these frequencies will be used for transmission up until the next change.” In other words; if DHU receives the correct frame it starts broadcasting to UHU on new frequencies and simultaneously saves it to Flash, which of course results in the fact that after reboot it will broadcast on these changed frequencies until the next change

The time window acts as additional protection against accidental change in the frequencies used by the DHU. It will be appreciated that software downhole communication does not have to be called only a certain time after the sensor is turned on, it can be called at other times.

Calling its specific time after turning on the power provides additional protection against accidental change of carrier frequency to transmit up.

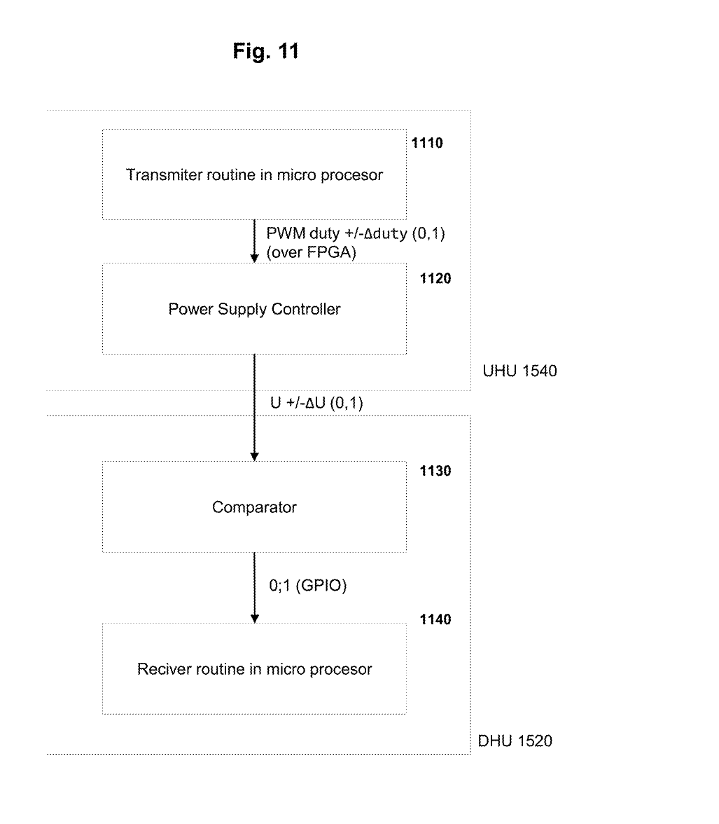

FIG. 11 is a block diagram illustrating an example operation transmission from the UHU (receiver) to the DHU (sensor). With additional reference to FIG. 9 (transmission down branch), the UHU in one example includes a transmitter routine in the microprocessor 1110. In this routine, in an exemplary embodiment data bits are coded to pulse width modulation (PWM) duty cycle levels for transmission to the Power Supply Controller 1120 in the UHU. Power Supply Controller 1120 in turn provides output voltage that is adjustable over the duty cycle. It will be appreciated that different systems have different power supply levels, and voltages may have to be preset based on the length of the cable connecting the DHU. Thus, voltage levels discussed herein are for illustration only, and may change in different practical applications.

Referring back to FIG. 11, voltage levels U+/−ΔU (0,1) are supplied to the DHU 1520, where in block 1130 they are received in a comparator. The input voltage received in 1130 is compared with the reference voltage (threshold). The system then detects a logical 1 if the input voltage is higher than the reference voltage, and detects a logical 0 if the input voltage is lower than the reference voltage. In the next block 1140, receiver routine in the downhole microprocessor arranges bits stream to data, i.e., F_{1L}, F_{1H}, F_{2L}, F_{2H} for use in the uphole transmission. It will be appreciated that in case when more than two frequencies are used for uphole communication, the receiver routine 1140 may be programmed to detect and extract the appropriate frequencies.

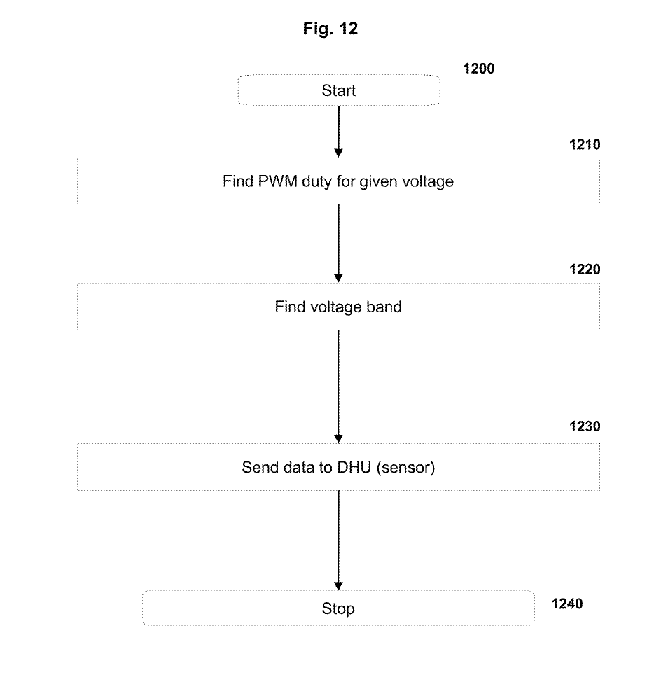

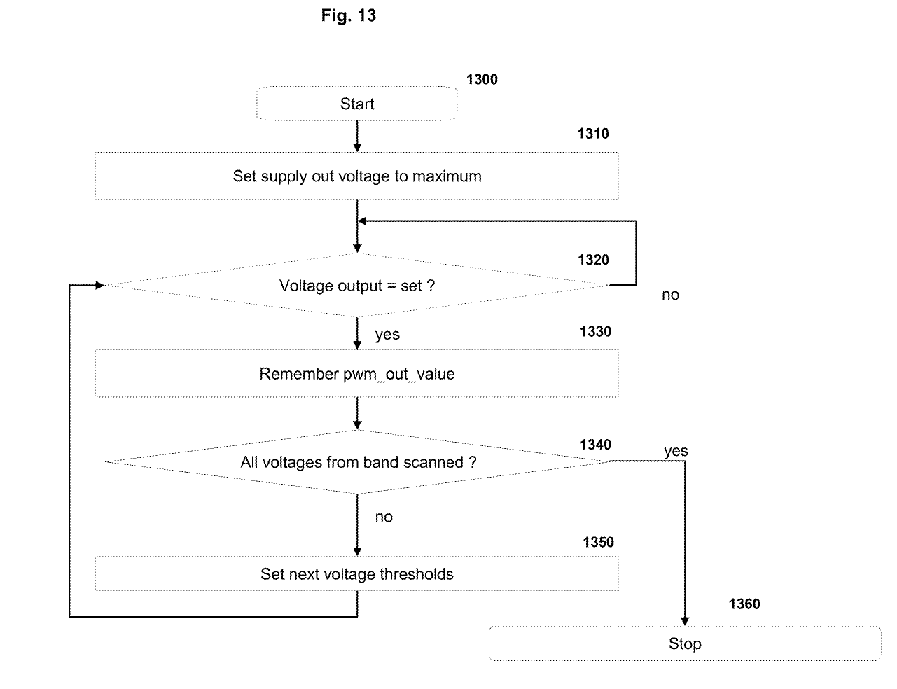

FIG. 12 is a block diagram illustrating an example of an algorithm with autosave voltage levels for sending data, i.e., frequencies to the DHU. FIG. 13 is a more detailed block diagram illustrating an example of an algorithm for finding voltage threshold for downhole transmission using autoscale levels procedure, to account for different systems.

In particular, the communications procedure in FIG. 12 starts in block 1200, and proceeds to block 1210 to determine the PWM duty for a given voltage level. In the following block 1220 the procedure finds the appropriate voltage band, that is determines pwm value for low level voltage and pwm value for high level voltage. Next, in 1230 data is sent to the DHU (sensor) 1520. In the sub-procedure illustrated in FIG. 13, in 1310 the supply output voltage is set to maximum. In the next block 1320, a comparator checks if the voltage output is equal to the one set and, if it is, forwards to the following block 1330 to remember the pwm out value.

The procedure 1210 in FIG. 12 and FIG. 13 sets the PWM values for the corresponding values of the sensor supply voltages, i.e. for the given voltage, it looks for the PWM fill factor for which the output receives the set voltage (PWM autoscaling).

The procedure 1220 in FIG. 12 searches for the appropriate value of the output voltage of the power supply controller 1120 shown in FIG. 11, which in turn will provide communication, i.e. a corresponding threshold, for switching the sensor comparator 1130 in FIG. 11.

Procedure 1230 in FIG. 12 is sending configuration data to the sensor by means of modulation of the sensor power supply frame voltage.

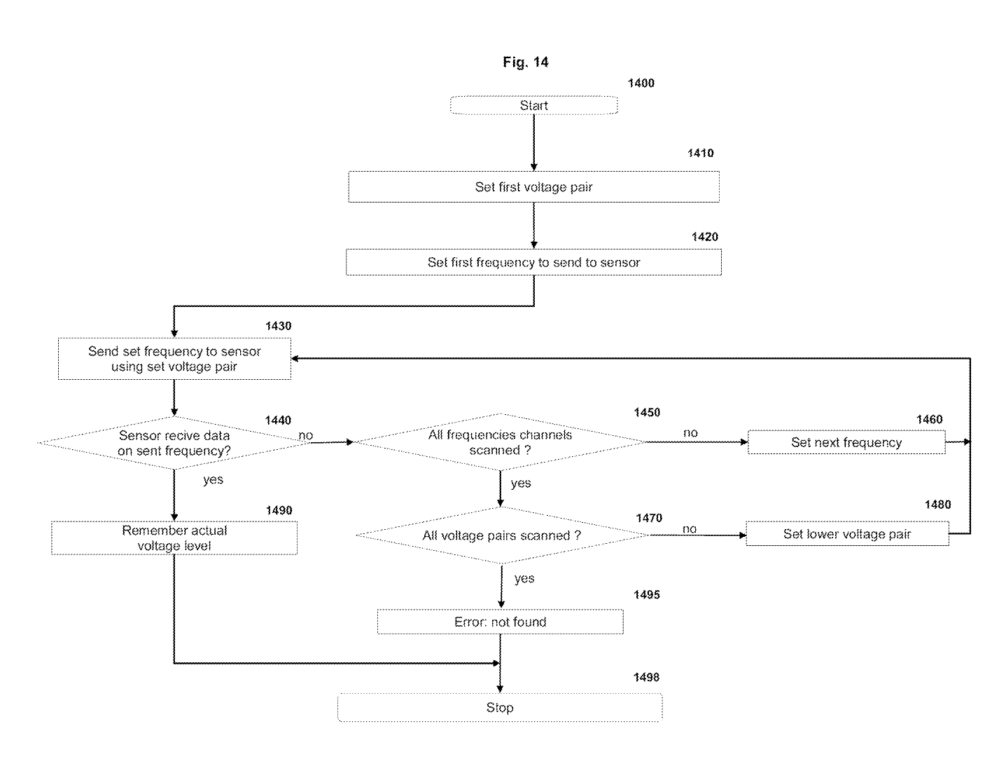

FIG. 14 is a block diagram illustrating an example of an algorithm for finding a voltage pair for transmission from the UHU to the DHU. Specifically, in 1410 and 1420 the first voltage pair and the first frequency for sending to DHU are set, respectively. In 1430, the set frequency is sent to the DHU (sensor). In the following block 1440, a check is made whether the sensor has received data on the set frequency. If the result from the check is yes, in block 1490 the actual voltage level is remembered. If the result from the check is no, in 1450 a check is conducted whether all frequency channels have been scanned. If the result from the check is negative, in 1460 the next frequency is set. If the result from the check is positive, in block 1470 a check is made whether all voltage pairs were scanned. If the answer to this check is affirmative, the procedure exits. If the answer to this check is negative, a lower voltage pair is set 1480, and the procedure loops back to block 1430. In sum, FIG. 14 procedure searches for the sensor supply voltage-voltage threshold for switching the sensor comparator 1130 in FIG. 11, where the voltage-frequency scanning method is applied.

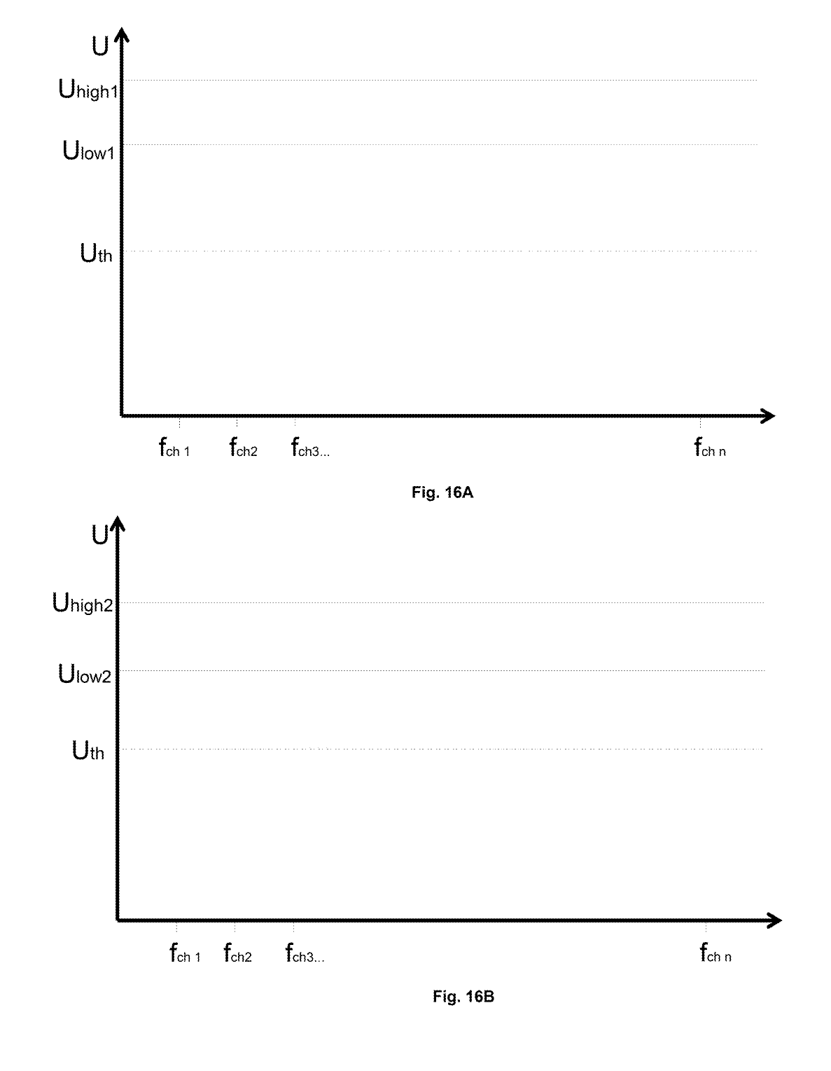

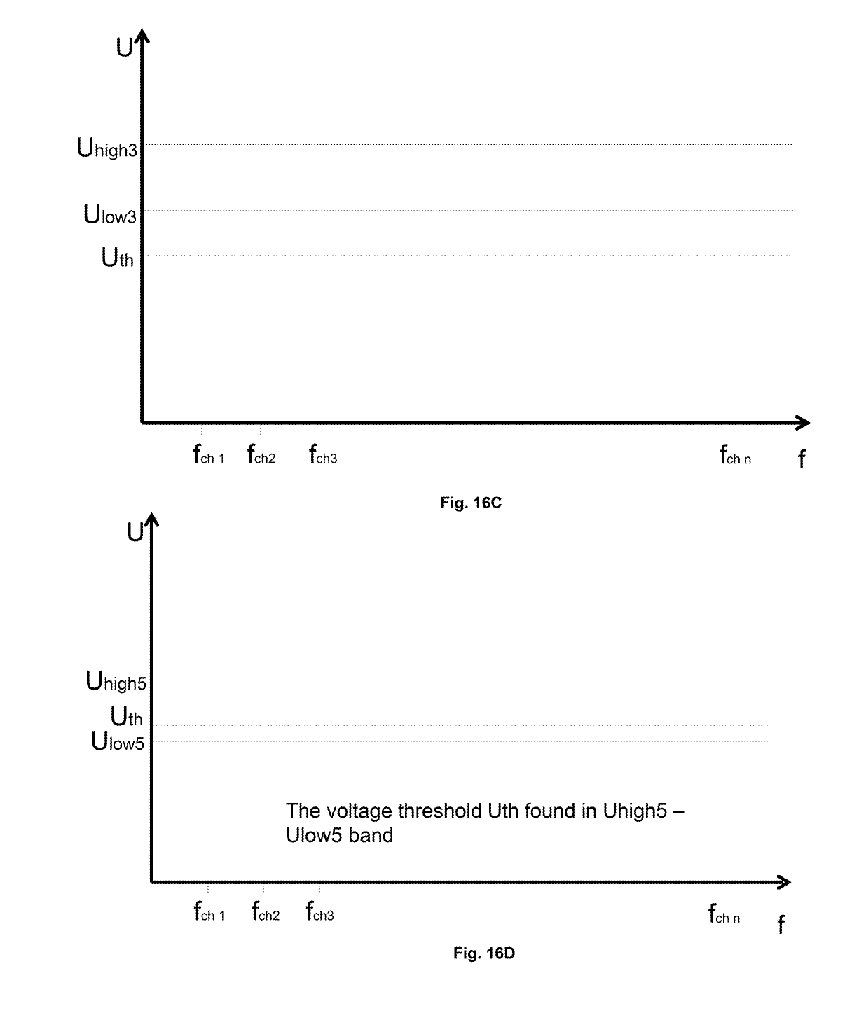

FIGS. 16A-16D further illustrate the process. From the entire voltage band Umax−Umin voltage supply, several pairs of voltages are selected for logic 1 and 0, that is, (U_{high 1},U_{low 1}), (U_{high 2},U_{low 2}), (U_{high 3},U_{low 3}), . . . , (U_{high n},U_{low n}), where n is an integer, as shown in FIG. 16A-16D. With further reference to FIG. 14, the scanning begins with the pair U_{high 1},U_{low 1} (in block 1410) and FIG. 16A with the highest voltages and follows to the lower voltages shown in FIG. 16B-16D. As shown in FIG. 14, the process continues down to processing block 1430 with the help of the selected pair of voltages. With further reference to the selection of a voltage pair in processing block 1480, and frequencies in 1460, the data is transmitted to the DHU sensor. With further reference to FIG. 10, the DHU sensor, after receiving in 1010 of the correct frame from the UHU, in 1020 the DHU sensor changes its transmission frequency in 1030 to the one obtained in the frame. Referring back to FIG. 14, if UHU receives in 1440 from the DHU on the down-set frequency, the confirmation then terminates the procedure and adopts the voltage band used for transmitting as suitable for downstream transmission 1490. Additionally, in order to protect against disturbances in the downhole sensor (i.e., additional protection against accidental change of carrier frequency to transmit up), a time window was used for transmission from the surface, counted down from powering the sensor in the DHU. Within this time window the sensor can choose the transmission from the UHU in 1040.

It will be appreciated that during normal operation there may be no need to communicate continuously downhole and the time window can be closed among other things to protect against accidental change in the carrier frequencies for uphole communication. However, in some situations when necessary to communicate data downhole, the time window may be reactivated, and the process be repeated.

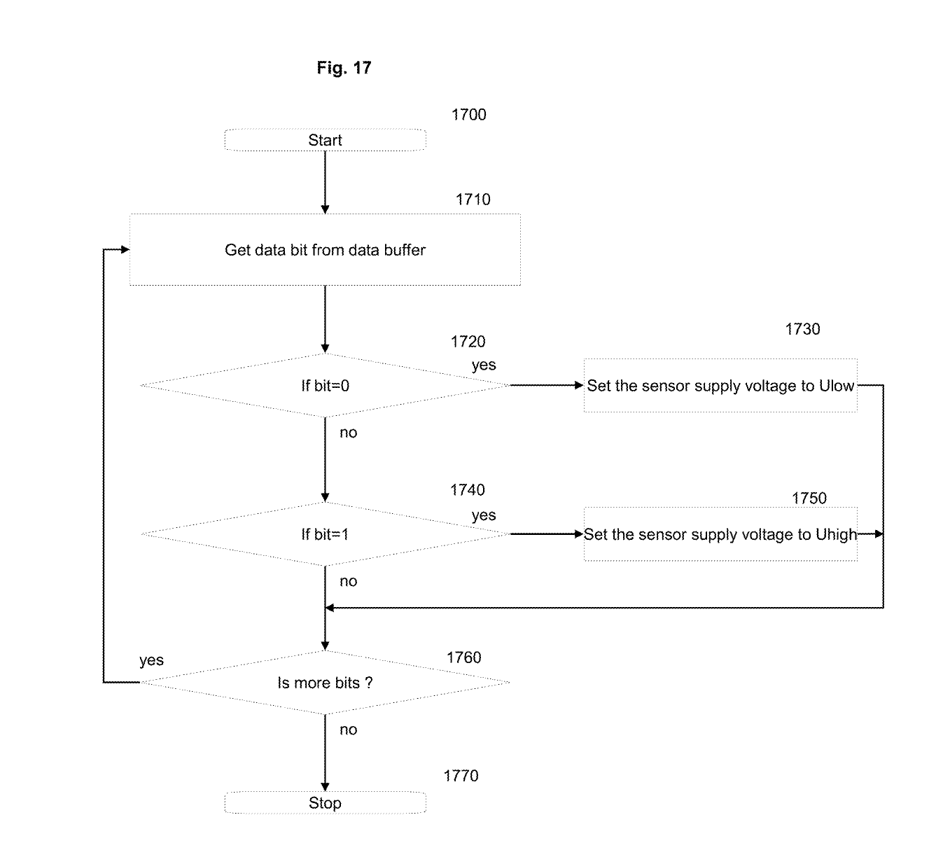

FIG. 17 is a block diagram illustrating an example UHU procedure to send data to DHU via sensor supply voltage levels. As illustrated, the data bits to be sent are taken from the data buffer 1710 and, depending on the logical value of bit 0, 1720, or 1, 1740, the corresponding sensor supply voltage is set at the output of the sensor power supply in 1730 or 1750, respectively. The operation is repeated in 1760 until the bits in the buffer are exhausted.

The present disclosure is directed to systems and methods of communicating data over a three phase power system between downhole equipment and a surface. As described above, in one method for transmitting data, the data is comprised of a combination of multiple frequencies from 1 to n transmitted in a unique sequence so that it cannot be replicated by any other source of electrical noise. In another method for transmitting data, each bit of the data is transmitted simultaneously as a different frequency. These two methods may be combined, as described above.

Also described herein is a method of transmitting and decoding data that includes sending data in a unique combination and/or sequence of frequencies, and correlation of the recovered data is performed to this known unique combination of frequencies and timing to provide robust decoding even in the presence of significant noise and coherent frequencies from another source. In addition, in a method of transmitting and decoding data, data is sent in a unique combination and/or sequence of frequencies. Fourier transforms may be performed on the recovered signal, specifically measuring average amplitude in a series of narrow frequency windows corresponding to the specific frequencies contained in the transmitted data. In this method, the FFT amplitude may be correlated to a specific pattern of sequential frequency combinations in time.

The present disclosure is also directed to bi-directional communication DHU, that enables adaptively changing the parameters of the uphole communication in order to avoid, for example, harmonic noise. The novel technique may potentially save huge costs by enabling communications with a DHU. In this mode of operation, after taking the correct date frame in the frequency setting window, the DHU encodes subsequent transmissions to UHU at new frequencies, and it saves the new frequency also in Flash memory on which it will work from now on. In case of reboot of the sensor (DHU), these frequencies will be used to transmit up to the time of re-change.

This written description uses examples to disclose the invention, including the best mode, and also to enable a person skilled in the art to make and use the invention. The patentable scope of the invention includes other examples. Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Further, as used in the description herein and throughout the claims that follow, the meaning of “each” does not require “each and every” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive of” may be used to indicate situations where only the disjunctive meaning may apply.

What is claimed is:

1. A data system coupled to an electric submersible pump (ESP), the system comprising:
an uphole unit (UHU);
a 3-phase power cable coupled to the UHU at one end and a 3-phase motor of an electrical submersible pump (ESP) at another end;
a downhole unit (DHU) coupled to the 3-phase motor of the ESP and located downhole in a well, the DHU comprising:
one or more sensors;
a transmitter sending data from the sensors via the 3-phase power cable uphole to the UHU using two or more frequencies;
wherein the UHU comprises a processor configured to provide to the DHU information about the two or more frequencies for sending data uphole, and the DHU further comprises a processor receiving the UHU-provided information and determining the two or more frequencies for sending uphole data.

2. The system of claim 1, wherein the two or more frequencies are selected to avoid sources of electrical noise.

3. The system of claim 1, wherein the UHU provided information is encoded using voltage supply data.

4. The system of claim 1, wherein the data from the sensors sent uphole is formatted by a DHU processor as a data frame comprising a plurality of bits corresponding to sensor data.

5. The system of claim 4, wherein the data frame further comprises CRC for ensuring the integrity of the data sent uphole.

6. The system of claim 1, wherein the UHU comprises a power supply controller providing predetermined voltage supply values.

7. The system of claim 6, wherein the DHU further comprises a comparator for determining, based on the received voltage supply values, of a sequence of binary values, corresponding to select frequencies for use in uphole data transmission.

8. The system of claim 4, wherein the DHU comprises at least one each of: a temperature sensor, a pressure sensor, and a voltage sensor.

9. A method of bi-directional communication of data over a three phase power system between downhole equipment and a surface, the method comprising the steps of:
transmitting downhole data from the surface to the downhole equipment, wherein the downhole transmission of data includes transmitting voltage levels corresponding to two or more frequencies to be used for subsequent uphole data transmission;
transmitting uphole data from the downhole equipment to the surface, wherein the uphole transmission includes transmitting sensor data using the two or more frequencies from the step of downhole transmission.

10. The method of claim 9, wherein a first combination of the two or more frequencies transmitted uphole is representative of a bit having a value of 0, and wherein a second combination of the two or more frequencies transmitted uphole is representative of a bit having a value of 1.

11. The method of claim 10, wherein a third combination of the two or more frequencies transmitted uphole is representative of a control symbol having a value of neither 0 nor 1.

12. The method of claim 9, wherein the two or more frequencies for uphole data transmission are selected to avoid the frequencies of known sources of electrical noise.

13. The method of claim 9, wherein sensor data transmitted uphole is arranged as a data frame that includes CRC code for protecting the integrity of the transmitted data.

14. The method of claim 9, wherein the step of transmitting data from the surface to the downhole equipment is performed during a predetermined time window.

15. The method of claim 9 further comprising,
(a) prior to the step of downhole transmission, the step of transmitting uphole data from the downhole equipment to the surface using two or more frequencies; and
(b) following the step of downhole transmission, the step of changing the frequency of at least one of the frequencies used for subsequent uphole data transmission.

16. A method of bi-directional data communication over a three phase power system between downhole equipment and a surface, the method comprising:
transmitting a data frame from the downhole equipment to the surface, wherein transmission of the data frame includes transmitting a combination of signals using two or more frequencies over a 3-phase power cable connecting the downhole equipment and the surface, and wherein the data frame transmitted uphole includes at least one of: a pressure data point, a temperature data point, a voltage data point and a CRC value; and
transmitting a data frame from the surface to the downhole equipment, wherein the downhole data frame comprises information about at least two frequencies for use in subsequent uphole transmissions.

17. The method of claim 16, wherein downhole data transmission occurs at initialization.

18. The method of claim 16, wherein downhole data transmission occurs during one or more pre-determined time windows.

19. The method of claim 16, wherein downhole data transmission is encoded using power supply voltage values.

20. The method of claim 16, further comprising the step of receiving the combination of transmitted uphole signals; sampling the received signal combination repeatedly in a time window; and processing the sampled window to decode the uphole data frame.
